(19) United States
(12) Patent Application Publication
(10) Pub. No.: US 2005/0278874 A1
(43) Pub. Date: Dec. 22, 2005

(54) Electric toothbrush

(75) Inventors: Lawrence A. Blaustein, Chagrin Falls, OH (US); John R. Nottingham, Bratenahl, OH (US); John Osher, Moreland Hills, OH (US); John W. Spirk, Gates Mills, OH (US); Douglas A. Gall, Strongsville, OH (US); John Geoffrey Chan, Maineville, OH (US)

Correspondence Address: THE PROCTER & GAMBLE COMPANY;INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company, Cincinnati, OH (US)

(21) Appl. No.: 11/171,889

(22) Filed: Jun. 30, 2005

Related U.S. Application Data
(63) Continuation-in-part of application No. 09/861,833, filed on May 21, 2001, now Pat. No. 6,932,216.
Application No. 09/861,833 is a continuation of application No. 09/710,616, filed on Nov. 9, 2000, now Pat. No. 6,371,294.
Application No. 09/710,616 is a continuation-in-part of application No. 09/382,745, filed on Aug. 25, 1999, now Pat. No. 6,178,579.
Application No. 09/382,745 is a continuation-in-part of application No. 09/236,794, filed on Jan. 25, 1999, now Pat. No. 6,189,693.
Application No. 09/236,794 is a continuation-in-part of application No. 09/163,621, filed on Sep. 30, 1998, now Pat. No. 6,000,083.

(51) Int. Cl. A61C 17/22

(52) U.S. Cl. 15/22.1; 15/28

(57) ABSTRACT

An electric toothbrush may comprise a handle at a first end of the toothbrush and having a motor disposed therein. The electric toothbrush may also comprise a head at a second end of the toothbrush. The head may comprise a first bristle group, a second bristle group, and a third bristle group. The head may further comprise at least one elastomeric element. Further, the head may comprise a moveable bristle holder which oscillates. The moveable bristle holder may comprise at least one elastomeric element in the shape of a prophy cup.

### CROSS REFERENCE TO RELATED APPLICATION

This application is a continuation-in-part of application Ser. No. 09/861,833, filed on May 21, 2001, which is a continuation of application Ser. No. 09/710,616, filed Nov. 9, 2000, which is a continuation-in-part of application Ser. No. 09/382,745, filed on Aug. 25, 1999, now U.S. Pat. No. 6,178,579, which is a continuation-in-part of application Ser. No. 09/236,794, filed on Jan. 25, 1999, now U.S. Pat. No. 6,189,693, which is a continuation-in-part of application Ser. No. 09/163,621, filed on Sep. 30, 1998, which issued as U.S. Pat. No. 6,000,983 on Dec. 14, 1999, the substances of which are hereby incorporated by reference.

### FIELD OF INVENTION

The present invention relates generally to electric toothbrushes.

### BACKGROUND OF THE INVENTION

Many electric toothbrushes utilize a bristle carrier that is powered or otherwise driven by an electric motor incorporated in the toothbrush. In many cases, such this includes a rotary motion. There is a desire whiten and polish teeth, and thus to promote the retention of toothpaste or dentifrice composition on a movable bristle carrier of an electric toothbrush, and particularly, along the interface between the ends of the bristles or cleaning elements and the surface of the teeth. Additionally, there is a desire to promote stimulation of the gums and an overall positive brushing experience (feel). In an electric toothbrush, powered motion of a bristle carrier may eject the dentifrice material from the bristle carrier, thereby possibly diminishing the effectiveness and/or concentration of agents within the dentifrice material. These agents can include anticaries agents, fluoride agents, anticalculus agents, antimicrobial agents, desensitizing agents, anesthetic agents, anti-inflammatory agents, abrasives, and whitening agents. As such, there is a desire to provide improved designs for retaining a dentifrice material while still providing effective cleaning of the teeth and delivering a positive mouth feel.

### SUMMARY OF THE INVENTION

An electric toothbrush may comprise a handle at a first end of the toothbrush and having a motor disposed therein. The electric toothbrush may also comprise a head at a second end of the toothbrush. The head may comprise a first bristle group, a second bristle group, and a third bristle group. The head may further comprise at least one elastomeric element.

### BRIEF DESCRIPTION OF THE DRAWINGS

The invention may take physical form in certain parts and arrangements of parts, preferred embodiments of which will be described in detail in this specification and illustrated in the accompanying drawings which form a part hereof, and wherein:

FIG. 1 is a perspective view of the electric toothbrush in accordance with a first preferred embodiment of the present invention;

FIG. 2 is a side elevational view of the electric toothbrush of FIG. 1;

FIG. 3 is a bottom elevational view of the electric toothbrush of FIG. 1;

FIG. 4 is a side elevational view in cross section of the electric toothbrush of FIG. 1;

FIG. 5 is an exploded perspective view of the electric toothbrush of FIG. 1;

FIG. 6 is an enlarged side elevational view in cross section of the motor and gear assembly of the electric toothbrush of FIG. 1;

FIG. 7 is an enlarged side elevational view in cross section of the head of the electric toothbrush of FIG. 1;

FIG. 8 is a front and side elevational view of the electric toothbrush in packaging;

FIG. 9 is a perspective view of the electric toothbrush in accordance with a second preferred embodiment of the present invention;

FIG. 10 is a side elevational view of the electric toothbrush of FIG. 9;

FIG. 11 is a bottom elevational view of the electric toothbrush of FIG. 9.

FIG. 12 is a perspective view of the electric toothbrush in accordance with a third preferred embodiment of the present invention.

FIG. 13 is a bottom elevational view of the angled shaft and head of the electric toothbrush in accordance with a fourth preferred embodiment of the present invention.

FIG. 14 is a side elevational view of the angled shaft and head of the electric toothbrush of FIG. 13.

FIG. 15 is a bottom elevational view of the angled shaft and head of the electric toothbrush in accordance with a fifth preferred embodiment of the present invention.

FIG. 16 is a side elevational view of the angled shaft and head of the electric toothbrush of FIG. 15.

### DETAILED DESCRIPTION OF THE PREFERRED EMBODIMENTS

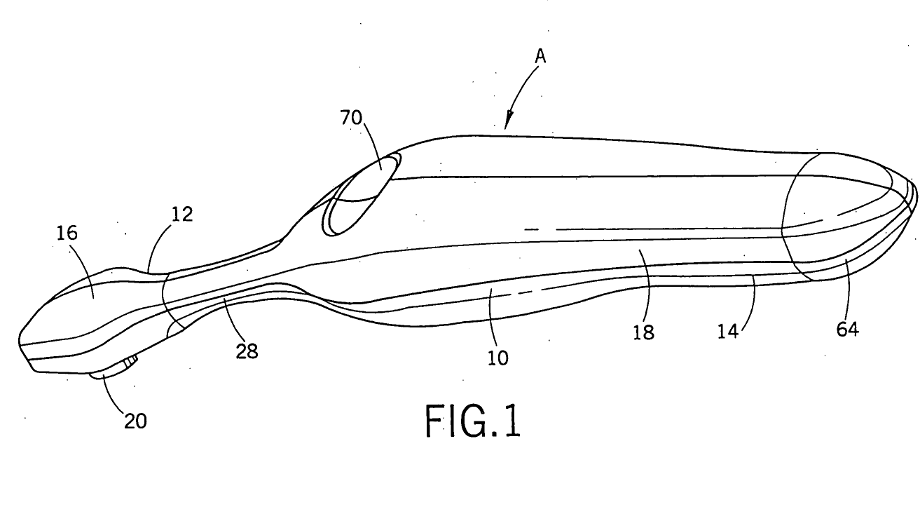

Referring now to the drawings wherein the showings are for the purposes of illustrating the preferred embodiments of the invention only and not for purposes of limiting same, FIG. 1 shows an electric toothbrush A according to a first preferred embodiment of the present invention. The electric toothbrush can be used for personal hygiene such as brushing one's teeth and gums.

As shown in FIG. 1, the electric toothbrush includes an elongated body portion 10, which has a first end 12 and a second end 14. A head 16 is attached to the first end 12 and a handle 18 is attached to the second end 14.

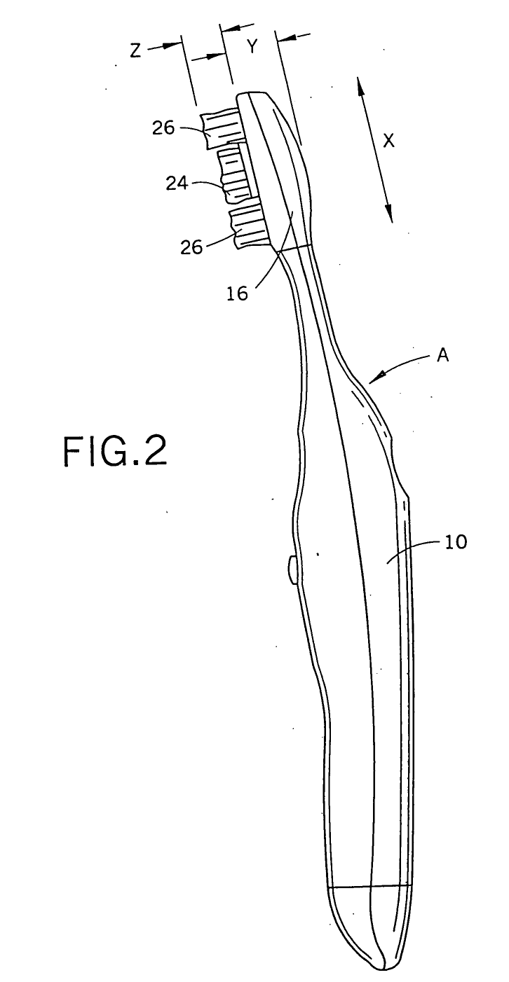

The head 16 has a more traditional larger brush head shape which permits the user to brush his teeth in the typical manner of an up and down fashion. As shown on FIG. 2, the length of the head 16, dimension “X”, can range from about 0.75 inches to about 1.75 inches. The thickness of the brush head, dimension “Y”, can range from about 0.25 inches to about 0.50 inches. The design of the head 16 allows for inexpensive manufacture and assists in bringing effective motorized rotational toothbrushes within the financial reach of a large portion of the population.

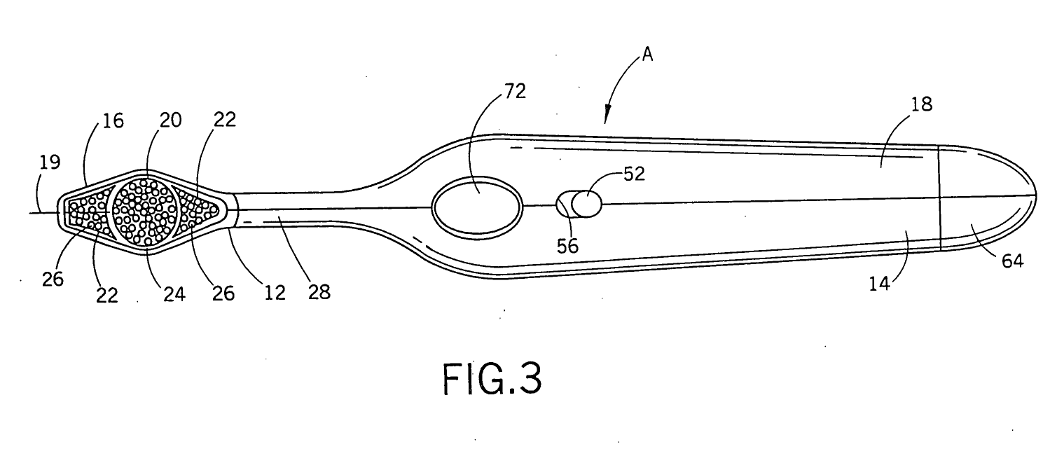

Referring now to FIG. 3, the head 16 further includes a longitudinal axis 19, a circular or moving portion or brush head 20 and a static portion or brush head 22. The static portion 22 is located on opposite sides of the moving portion 20. The moving portion 20 is located at the center of the brush head 16. The moving portion 20 rotates, swivels, oscillates or reciprocates about an axis approximately normal to the longitudinal axis 19 of the brush head 16. The moving portion 20 may rotate 360° or partially rotate or oscillate or reciprocate in a back and forth manner.

The moving portion 20 includes stiff bristles 24. The static portion 22 includes soft bristles 26. The stiff bristles 24 are slightly recessed with respect to the soft bristles 26. The stiff bristles 24 aid in the deep cleaning and plaque removal process, while the stationary soft bristles 26 are softer so as to not damage the gums. The thickness of the bristles, dimension “Z”, shown in FIG. 2, can range from about 0.25 inches to about 0.75 inches.

Referring again to FIG. 3, the elongated body portion 10 further includes an angled shaft 28, located between the head 16 and the handle 18. The angled shaft 28 provides an ergonomic benefit that has not been utilized on a motorized toothbrush. The angle is well known for its ergonomic benefit in permitting easier access into the back recesses of the mouth while still contacting the tooth surface.

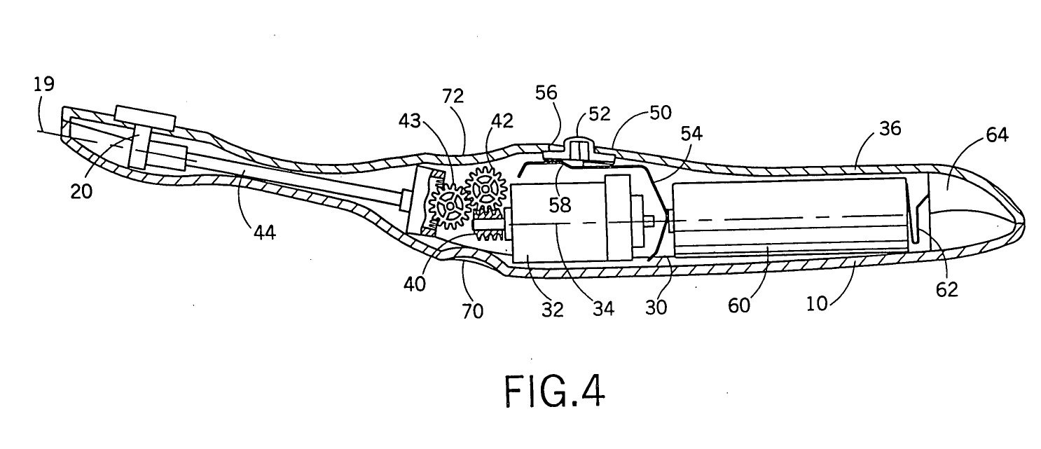

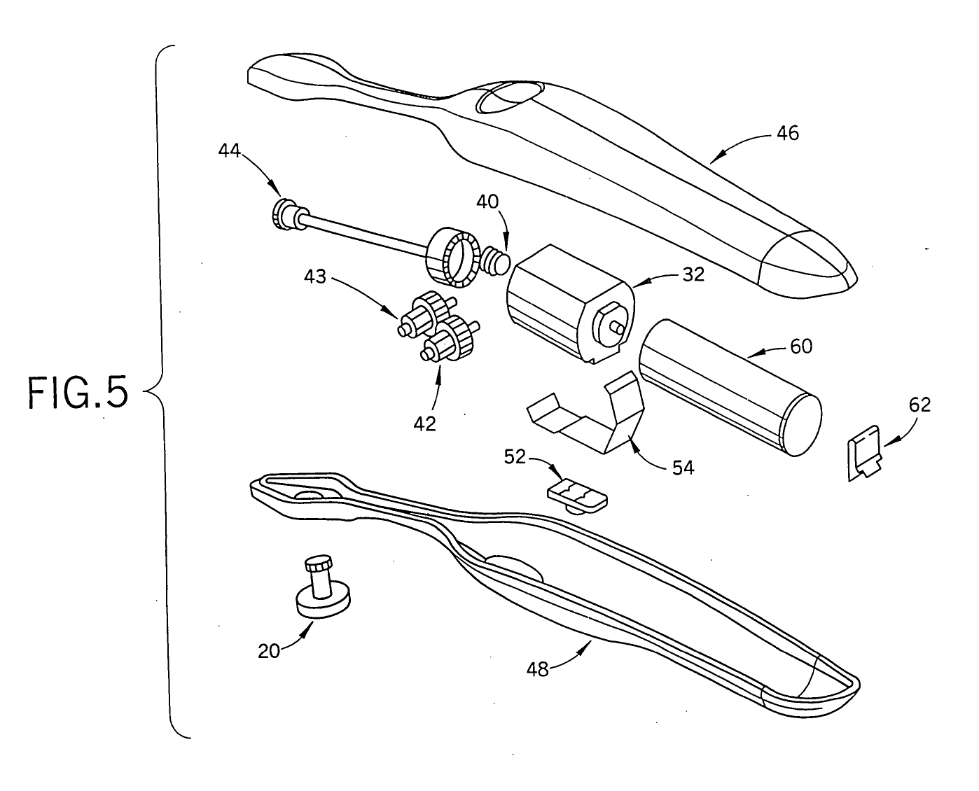

As shown in FIG. 4 and FIG. 5, the elongated body portion 10 further includes a hollow portion 30 which houses a motor 32. The motor 32 has a longitudinal axis 34 in line with a longitudinal axis 36 of the elongated body portion 10.

To provide power to the moving portion 20 to rotate or oscillate or reciprocate, the motor 32 powers a worm gear 40 and a pair of step gears 42, 43. The motor 32 is operatively connected to the worm gear 40. Step gear 42 is operatively connected to step gear 43 and the worm gear 40.

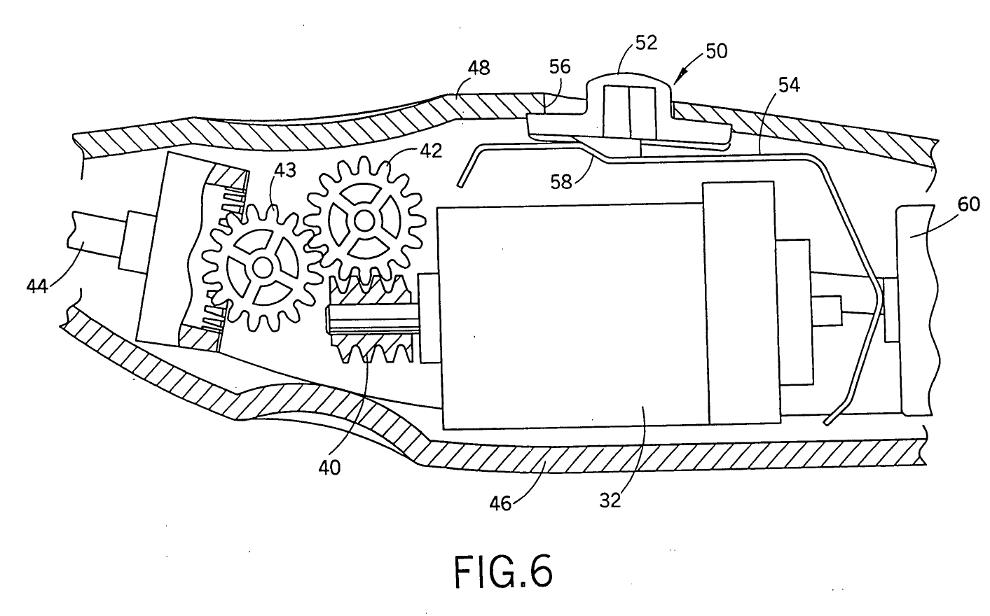

As shown in FIG. 4 and FIG. 6, the first step gear 42 permits the matching second step gear 43 to be offset with respect to the longitudinal axis 36 of the elongated body portion 10.

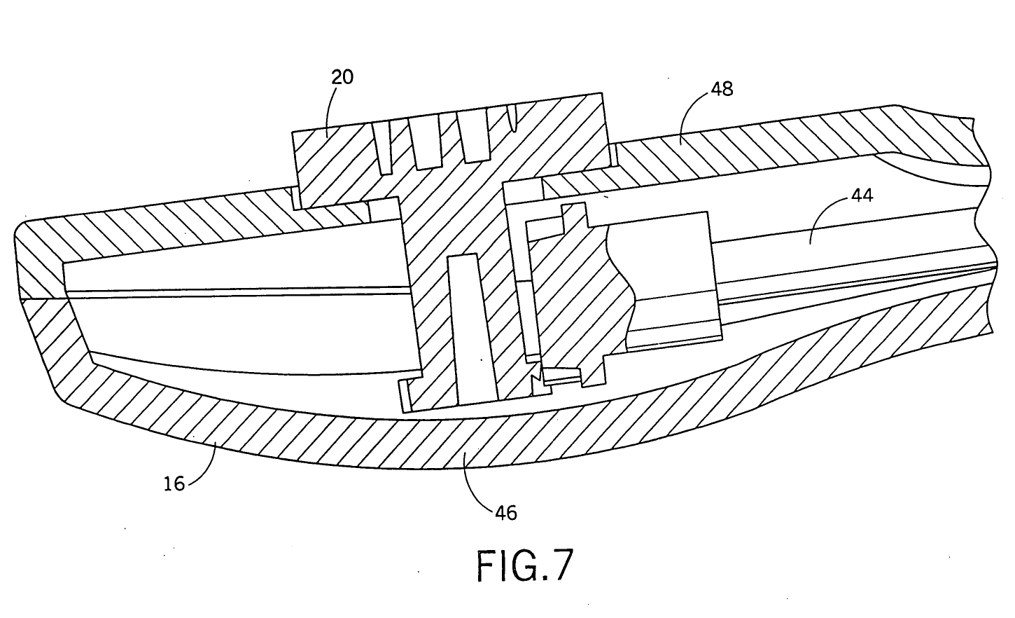

As shown in FIGS. 4, 6 and 7, a shaft 44 is connected at a first end to the offset step gear 43 and at a second end to the moving portion 20. The second step gear 43 is placed at a desired angle so that the shaft 44 itself can still be straight, thus losing no power or torque through the added function of a flexible shaft. While the shaft 44 may be configured to rotate or oscillate, a wide array of drive motor and/or gearing configurations (including shaft(s) which reciprocate and orbit) may be utilized in the preferred embodiment toothbrushes described herein. For example, various drive mechanisms described in U.S. Ser. No. 10/128,018, filed on Apr. 22, 2002; U.S. Ser. No. 10/208,213, filed on Jul. 30, 2002; U.S. Ser. No. 854,670, filed on Sep. 5, 1990 (PCT), now U.S. Pat. No. 5,311,633; U.S. Ser. No. 256,520, filed on Oct. 29, 1993 (PCT), now U.S. Pat. No. 5,577,285; U.S. Ser. No. 08/739,092, filed on Oct. 28, 1996, now U.S. Pat. No. 5,974,615; U.S. Ser. No. 09/425,262, filed on Oct. 22, 1999, now U.S. Pat. No. 6,195,828; U.S. Ser. No. 10/351,845, filed on Jan. 27, 2003; may be utilized.

Referring again to FIG. 5, the motor 32 and gears 40, 42, 43 are housed with an upper housing 46 and a lower housing 48.

Referring again to FIG. 4, a switch 50 is provided to control operation of the electric toothbrush and is operatively connected to the motor 32. The switch 50 includes a molded actuator button 52 and a metal contact 54. The switch 50 is manually depressed by pressing a molded actuator button 52 down, which then presses against a metal contact 54, which completes the circuit and provides momentary operation of the toothbrush. The switch 50 also allows continuous operation through a ramp design, sliding the button 52 forward toward the head 16 to provide for continuous operation. Moving the button 52 forward, combined with a molded in ramp 58 in the metal contact 54, causes the button 52 to move downward, pressing against the metal contact 54 and completing the circuit. The toothbrush then continuously operates until the button 52 is slid back into an off position toward the handle 18 and the button 52 disengages the metal contact 54.

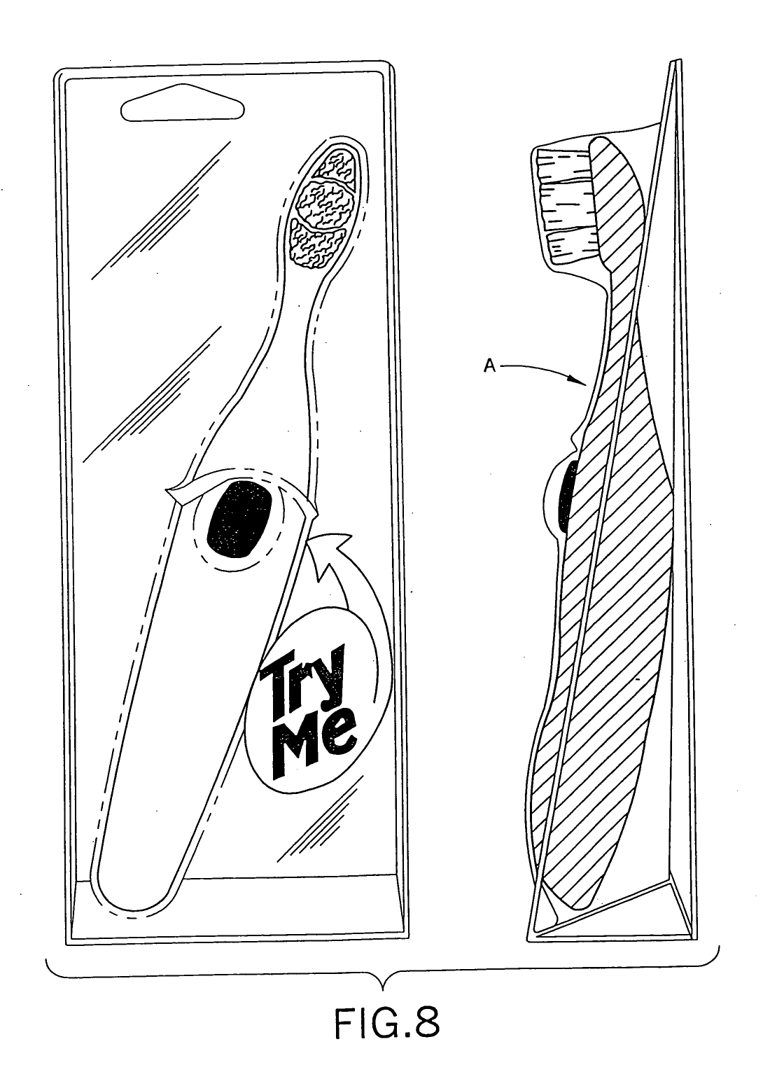

By combining these two functions in one switch 50, the toothbrush can be packaged in packaging as shown in FIG. 8 where the consumer can depress the button 52 through the packaging and see its operation while still inside the packaging, and then be able to operate it continuously once out of the package. FIG. 8 illustrates one version of the button 52. It should be noted that other sizes and shapes of buttons may be used.

Referring now to FIGS. 4 and 5, a battery 60 is provided within the hollow portion 30 of the elongated body portion 10. A battery terminal or contact 62 is provided for the battery 60. An AA battery can be used as is illustrated in FIG. 4. To install the battery 60 into the hollow portion 30, a slidable snap-on cover 64 is depressed and slid off the end of the handle 18 to expose the hollow portion 30. The battery 60 is inserted, then the cover 64 is slid back on to the housing and snapped into place. The terminal end of the battery 60 is then in contact with the metal contact 54.

If desired, depressions or grip areas 70 and 72 can be molded into the upper and lower housings 46, 48 as shown in FIG. 4. The depressions 70, 72 are used to support a user's thumb and forefinger or other fingers to make using the electric toothbrush easier and more comfortable.

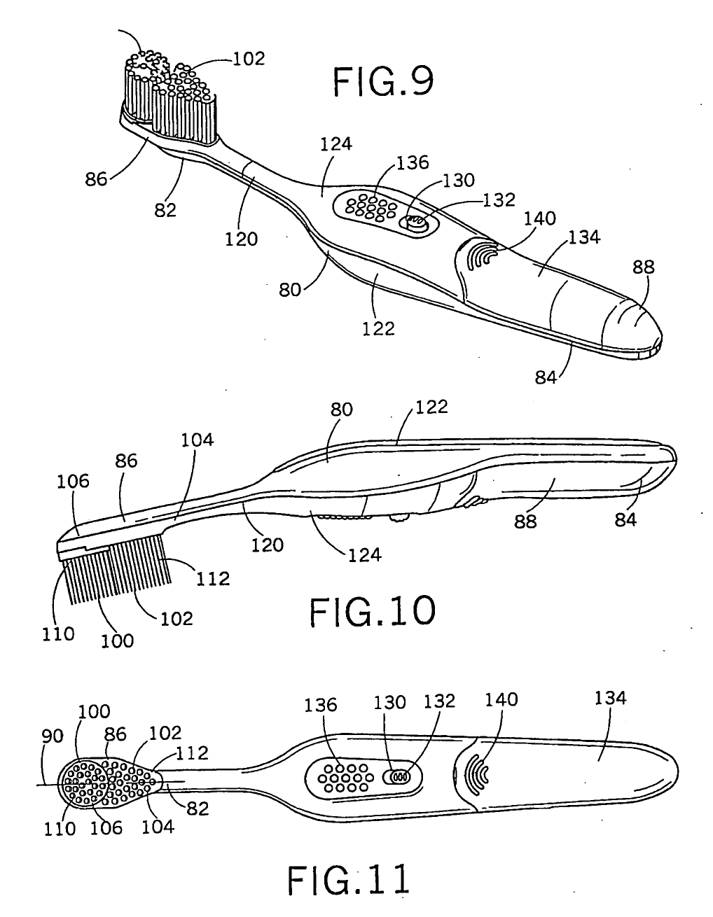

A second preferred embodiment of the electric toothbrush according to the present invention is shown in FIG. 9.

The electric toothbrush includes an elongated body portion 80 which has a first end 82 and a second end 84. A head 86 is attached to the first end 82 and a handle 88 is attached to the second end 84.

Referring now to FIG. 11, the head 86 further includes a longitudinal axis 90, a circular or moving portion or brush head 100, a static portion or brush head 102, a first end 104, and a second end 106. The first end 104 is located adjacent the first end 82 of the elongated body portion 80. The second end 106 is located opposite the first end 104. The circular moving portion 100 is preferably located at the second end 106 of the brush head 86. The static portion 102 is preferably located at the first end 104 of the brush head 86 adjacent the moving portion 100. However, it is to be appreciated that the moving portion 100 and the static portion 102 can be arranged in different orientations. The moving portion 100 rotates, swivels, oscillates or reciprocates about an axis approximately normal to the longitudinal axis 90 of the brush head 86.

The second preferred embodiment also has a worm gear 40 and a pair of step gears 42, 43 as shown in FIGS. 4 and 6. The motor 32 powers the worm gear 40 and the pair of step gears 42, 43. The step gear 42 permits the matching step gear 43 to be offset with respect to the longitudinal axis of the elongated body portion 80.

As shown in FIGS. 4, 6, and 7, a shaft 44 is connected at a first end to the offset step gear 43 and at a second end to the moving portion 100. The second step gear 43 is placed at a desired angle so that the shaft 44 can still be straight, thus losing no power or torque through the added function of a flexible shaft.

Referring again to FIG. 9, a switch 130 is provided to control operation of the electric toothbrush and is operatively connected to the motor 32. The switch 130 includes a molded actuator button 132. The switch 130 is manually depressed by pressing a molded actuator button 132 down, which then presses against a metal contact 54, which completes the circuit and provides momentary operation of the toothbrush. The operation of the switch 130 is identical to that shown in FIGS. 4 and 6 and as described for the first preferred embodiment. The switch 130 also allows continuous operation through a ramp design, sliding the button 132 forward toward the head 86 to provide for continuous operation. The toothbrush then continuously operates until the button 132 is slid back into an off position toward the handle 88 and the button 132 disengages the metal contact 54.

As shown in FIGS. 4 and 5 for the first preferred embodiment, the second preferred embodiment also has a battery 60 with a battery terminal or contact 62 provided within the hollow portion 30 of the elongated body portion 80. To install the battery 60 into the hollow portion 30, a slidable snap-on cover 134 (shown in FIGS. 9-11) is depressed and slid off the end of the handle 88 to expose the hollow portion 30. The battery 60 is inserted, then the cover 134 is slid back on to the housing and snapped into place.

If desired, raised grip areas 136 can be molded into the lower housing 124 as shown in FIG. 9 and FIG. 11. The raised portions 136 are used to support a user's thumb and forefinger or other fingers to make using the electric toothbrush easier and more comfortable. Raised portion 140 may also be molded onto the snap-on cover 134 to aid in gripping the cover with one's thumb and removing the cover from the handle 88.

The electric toothbrush of the second preferred embodiment can also be packaged in packaging as shown in FIG. 8 as shown for the first preferred embodiment where the consumer can depress the button 132 through the packaging and see its operation while still inside the packaging, and then be able to operate it continuously once out of the packaging.

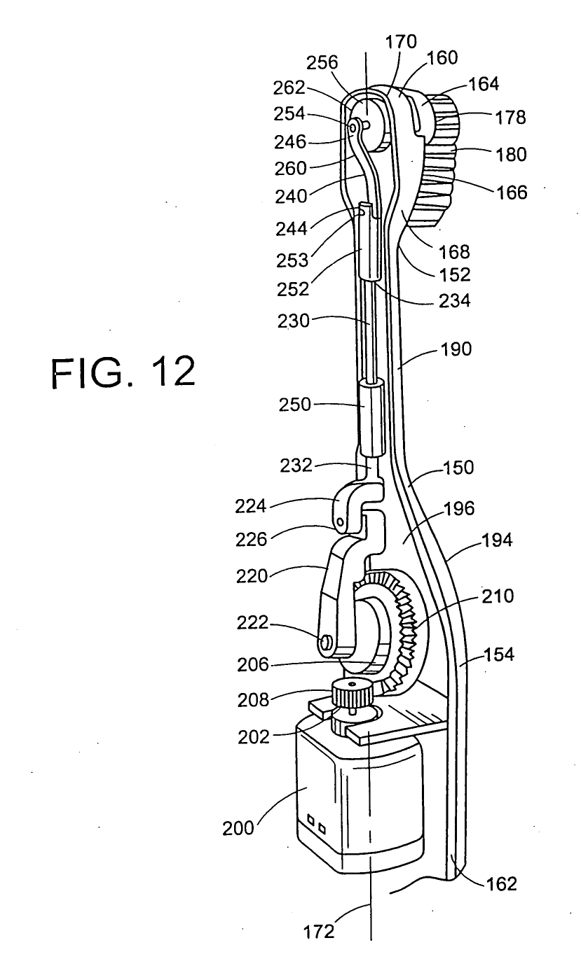

A third preferred embodiment of the present invention is shown in FIG. 12.

The electric toothbrush includes an elongated body portion 150 which has a first end 152 and a second end 154. A head 160 is attached to the first end 152 and a handle 162 is attached to the second end 154.

The head 160 further includes a moving portion or brush head 164, a static portion or brush head 166, a first end 168, and a second end 170. As shown in FIG. 12, the moving portion 164 is located adjacent the second end 170. The static portion 166 is shown located adjacent the first end 168. However, it is to be appreciated that the moving portion 164 could be located adjacent the first end 168, and the static portion 166 could be located adjacent the second end 170. Furthermore, the moving portion 164 could be positioned in the center of the brush head with static portions 166 on opposite sides of the moving portion 164 similar to that shown in FIG. 3.

In accordance with this embodiment, the moving portion 164 oscillates about an axis approximately normal to a longitudinal axis 172 of the elongated body portion 150.

The moving portion 164 can include stiff bristles 178. The static portion 166 can include soft bristles 180 which are softer than the stiff bristles. The stiff bristles 178 may be slightly recessed with respect to the soft bristles 180. The stiff bristles 178 aid in the deep cleaning and plaque removal process, while the stationary soft bristles 180 are softer so as to not damage the gums.

The elongated body portion 150 further includes an angled shaft 190, an upper housing 192 (not shown), and a lower housing 194. The angled shaft 190 is located between the head 160 and the handle 162. The angled shaft 190 provides an ergonomic benefit that has not been utilized on a motorized toothbrush.

The elongated body portion 150 of the third preferred embodiment also includes a hollow portion 196 which houses a motor 200. The hollow portion 196 is formed between the upper housing 192 and the lower housing 194. The motor 200 provides power to the moving portion 164 to rotate or oscillate or reciprocate. Power is provided to the motor by battery as shown and described for the first embodiment.

A switch (not shown) can be provided which is similar to switch 130 shown in FIGS. 9 and 11 and which functions as described for the first and second preferred embodiments.

The third embodiment further includes a first gear 202 which is operatively connected to and powered by the motor 200. The first gear 202 rotates about the longitudinal axis 172 of the elongated body portion 150. A second gear 206 is operatively connected to the first gear 202. The second gear 206 is approximately normal to the first gear 202. The second gear 206 rotates about an axis approximately normal to the longitudinal axis 172. Teeth 208 of the first gear 202 mesh with teeth 210 of the second gear 206, thus causing second gear 206 to rotate when first gear 202 rotates.

A first swivel arm 220 is pivotably connected to the second gear 206 via a pin 222 or other fastening device. A second swivel arm 224 is pivotably connected to the first swivel arm 220 via a pin 226 or other fastening device. A shaft 230 is fixedly secured at a shaft first end 232 to the second swivel arm 224. The shaft 230 is pivotably attached at a shaft second end 234 to a third swivel arm 240. The shaft 230 is housed within the angled shaft 190.

The shaft 230 is generally parallel with the longitudinal axis 172.

A guide spacer 250 is located within the angled shaft 190 and surrounds the shaft 230 adjacent the first end 232 of the shaft 230 to minimize lateral movement of the shaft 230. A second guide spacer 252 is located adjacent the second end 234 of the shaft 230 to also minimize lateral movement of the shaft 230. Guide spacers 250, 252 align the shaft 230 within the angled shaft 190 and minimize its movement from side to side within the angled shaft 190.

The third swivel arm 240 has a first end 244 and a second end 246. The third swivel arm 240 is pivotably connected to the second guide spacer 252 at the swivel arm first end 244 via a pin 253. The third swivel arm 240 is connected at the swivel arm second end 246 to the moving portion 164 via a pin 254 or other fastening device. The pin 254 is connected to a disk 256 of the moving portion 164 which is housed within the head 160.

As the first gear 202 rotates, the second gear 206 is rotated, thus moving the first swivel arm 220 in a back and forth circular fashion about the second gear 206 and along the longitudinal axis 172. The first swivel arm 220 also can pivot about the pin 222. The first swivel arm 220 retains its orientation of approximately parallel to the longitudinal axis 172 of the elongated body portion 150 during movement. The second swivel arm 224 pivots with respect to its pin connection 226 with the first swivel arm 220 thus allowing the shaft 230 to oscillate in a back and forth manner toward and away from the brush head with minimal lateral motion.

During operation, the third swivel arm 240 moves back and forth along the longitudinal axis 172 of the elongated body portion 150 along with the shaft 230.

The swivel arm 240 can also pivot or move slightly laterally in a direction perpendicular to the longitudinal axis.

The third swivel arm 240 has an offset arm 260 which is offset from the longitudinal axis 172 and moves the disk 256 of the moving portion 164 in a partially rotating or oscillating motion. As the third swivel arm 240 moves back and forth, the offset arm 260 moves along an outside edge 262 of the disk 256 in a partially rotating or oscillating fashion about an axis which is approximately normal to the longitudinal axis 172. This causes the bristles 178 to also move in a partially rotating or oscillating manner about an axis approximately normal to the longitudinal axis 172.

When the third swivel arm 240 rotates, the disk 256 also rotates about an axis approximately normal to the elongated body portion longitudinal axis 172. The third, swivel arm 240 also retains its orientation of approximately parallel to the elongated body portion longitudinal axis 172 during movement.

If desired, raised grip areas (not shown) can be provided which are similar to raised grip areas 138 and 140 shown in FIG. 9 and FIG. 11 for the second preferred embodiment. The raised grip areas can be molded into the lower housing 194.

The electric toothbrush of the third preferred embodiment can also be packaged in packaging as shown in FIG. 8 as shown for the first preferred embodiment. The consumer can depress a button (not shown) similar to button 132 shown in FIG. 9 and FIG. 11 for the second preferred embodiment through the packaging and see its operation while still inside the packaging, and then be able to operate it continuously once out of the packaging.

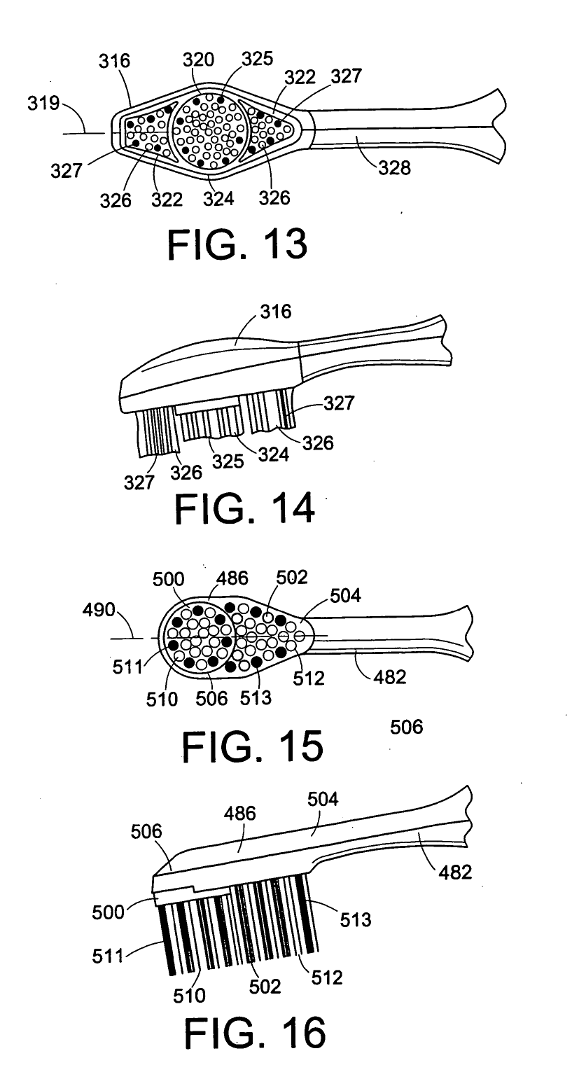

A fourth embodiment of the present invention is shown in FIGS. 13 and 14. The head of the electric toothbrush is illustrated. The remaining portion of the brush, including the handle, motor, etc. is the same as described for any of the previously described embodiments. As shown in FIG. 13, a head 316 includes a longitudinal axis 319, a circular or moving portion or brush head 320 and a static portion or brush head 322. The head 316 is located adjacent a first end 328 of an elongated body portion. The static portion 322 is located on opposite sides of the moving portion 320. The moving portion 320 is located at the center of the brush head 316. The circular portion 320 rotates, swivels, oscillates or reciprocates about an axis approximately normal to the longitudinal axis 319 of the brush head. The circular portion 320 may rotate 360 degrees or partially rotate or oscillate or reciprocate in a back and forth manner.

The moving portion 320 includes bristles 324 and elastomeric elements 325. Elastomeric elements 325 may also be referred to as “massaging tips/bristles/elements”, “polishing tips/bristles/elements”, or “whitening tips/bristles/elements”. The static portion 322 includes bristles 326 and elastomeric elements 327. The elastomeric elements 325, 327 massage the gums and/or polish and whiten the teeth, depending on their size, shape, number, and placement on the bristle holder. The elastomeric elements 325, 327 can be made from a rubber, soft plastic or similar material, including, but not limited to, thermoplastic elastomer (“TPE”), a thermoplastic olefin (“TPO”), a soft thermoplastic polyolefin (e.g., polybutylene), or may be selected from other elastomeric materials, such as etheylene-vinylacetate copolymer (“EVA”), and ethylene propylene rubber (“EPR”). Examples of suitable thermoplastic elastomers herein include styrene-ethylene-butadiene-styrene (“SEBS”), styrene-butadiene-styrene (“SBS”), and styrene-isoprene-styrene (“SIS”). Examples of suitable thermoplastic olefins herein include polybutylene (“PB”), and polyethylene (“PE”), as well as those materials described in U.S. Ser. No. 10/410,038, filed on Apr. 9, 2003. Techniques known to those of skill in the art, such as injection molding, can be used to manufacture the toothbrush of the present invention.

The elastomeric elements 325, 327 may be various shapes, including, but not limited to, cylindrical, oval, rectangular, triangular, or conical. The elastomeric elements 325, 327 may be solid or may be completely (from end to end) or partially hollow. Hollow elastomeric elements 28 may be closed at both ends, or open at the top end (that is, the end which is not fixed to a bristle plate). The elastomeric elements 325, 327 may be tapered or contoured. A single elastomeric element may form a wall (not shown). Examples of elastomeric walls and wall configurations are disclosed in U.S. Ser. Nos. 60/439,317, filed Jan. 10, 2003; 60/463,347, filed Apr. 15, 2003; 10/410,038, filed Apr. 9, 2003; 10/260,585, filed Sep. 27, 2002; and 10/260,586, filed Sep. 27, 2002; and in U.S. Pat. Nos. 6,319,332, filed Jun. 11, 1999; 6,571,417, filed Jun. 5, 2000; 6,446,295, filed on Jun. 26, 2000; 60/613,627, filed Sep. 27, 2004; 10/364,148, filed Feb. 11, 2003. The elastomeric elements 325, 327 may extend at 90 degrees relative to the head 316, or may extend at an acute angle.

The elastomeric elements 325, 327 extend essentially perpendicularly from the head 316 as measured along the longitudinal axis 319. In the preferred embodiment the elastomeric elements 325, 327 are located around the perimeter of the circular portion 320 and the static portion 322, however it is to be understood that the elastomeric elements can be located anywhere among the bristles of the moving portion 320 and the static portion 322. The length of the elastomeric elements 325, 327 is approximately the same length as the bristles 324, 326. The elastomeric elements 325, 327 may extend slightly above, slightly below or to the same height as the bristles 324, 326.

In a fifth preferred embodiment of the electric toothbrush as shown in FIGS. 15 and 16, a head 486 includes a longitudinal axis 490, a circular or moving portion or brush head 500, a static portion or brush head 502, a first end 504 and a second end 506. The first end 504 is located adjacent to the first end 482 of the elongated body. The second end 506 is located opposite the first end 504. The moving portion 500 is preferably located at the second end 506 of the brush head 486. The static portion 502 is preferably located at the first end 504 of the brush head 486 adjacent the moving portion 500. However, it is to be appreciated that the moving portion 500 and the static portion 502 can be arranged in different orientations. The moving portion 500 can rotate, swivel, oscillate or reciprocate about an axis approximately normal to the longitudinal axis 490 of the brush head 486.

The moving portion 500 includes bristles 510 and elastomeric elements 511. The static portion 502 includes bristles 512 and elastomeric elements 513. The elastomeric elements 511, 513 massage the gums while the user brushes his or her teeth. The elastomeric elements 511, 513 can be made from a rubber, soft plastic or similar material. The elastomeric elements 511, 513 extend essentially perpendicularly from the head 486 as measured along the longitudinal axis 490. In the preferred embodiment the elastomeric elements 511, 513 are located around the perimeter of the moving portion 500 and the static portion 502, however it is to be understood that the elastomeric elements can be located anywhere among the bristles of the moving portion 500 and the static portion 502. The length of the elastomeric elements 511, 513 is approximately the same length as the bristles 510, 512. The elastomeric elements 511, 513 may extend slightly above, slightly below or to the same height as the bristles 510, 512.

It is significant to note that any of the features, aspects, or details of any method and/or product described herein can be combined, either entirely or partially, with any other feature, aspect, or detail of one or more other methods or products described herein. While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

All documents cited above are incorporated herein by reference; the citation of any document is not to be construed as an admission that it is prior art with respect to the invention.

While particular embodiments of the invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. An electric toothbrush comprising:
a handle at a first end of the toothbrush having a motor disposed therein;
a head at a second end of the toothbrush, the head comprising a first bristle group, a second bristle group, and a third bristle group; and
wherein the head further comprises at least one elastomeric element.

2. The electric toothbrush of claim 1, wherein the elastomeric element is lower than the three bristle groups.

3. The electric toothbrush of claim 2, wherein the head comprises multiple elastomeric elements.

4. The electric toothbrush of claim 2, wherein the head further comprises a movable bristle holder, and wherein the moveable bristle holder comprises at least one elastomeric element.

5. The electric toothbrush of claim 4, wherein the moveable bristle holder comprises a plurality of elastomeric elements.

6. The electric toothbrush of claim 5, wherein the movable bristle holder is generally circular and wherein the elastomeric elements are arranged in a generally alternating fashion about the perimeter of the bristle holder.

7. The electric toothbrush of claim 6, wherein the elastomeric elements are cylindrical.

8. The electric toothbrush of claim 4, wherein the first, second, and third bristle groups vary in height.

9. The electric toothbrush of claim 8, wherein a shaft is operatively connected to the motor to move the bristle holder in an oscillating motion.

10. The electric toothbrush of claim 9, wherein the shaft orbits.

11. An electric toothbrush comprising:
a handle at a first end of the toothbrush having a motor disposed therein;
a head at a second end of the toothbrush, the head comprising a first bristle group, a second bristle group, and a third bristle group;
a moveable bristle holder comprising an elastomeric element;
a shaft operatively connected to the motor and moveable bristle holder; and
wherein the elastomeric element is in the shape of a prophy cup.
